(19) United States
(12) Patent Application Publication
(10) Pub. No.: US 2025/0110228 A1
(43) Pub. Date: Apr. 3, 2025

(54) VEHICLE MONITORING AND ENERGY HARVESTING SYSTEMS AND METHODS

(71) Applicant: JOYSON SAFETY SYSTEMS ACQUISITION LLC, AUBURN HILLS, MI (US)

(72) Inventors: Len Cech, Brighton, MI (US); Joshua Ramaglia, Broken Arrow, OK (US)

(21) Appl. No.: 18/901,900

(22) Filed: Sep. 30, 2024

Related U.S. Application Data
(60) Provisional application No. 63/586,752, filed on Sep. 29, 2023.

(51) Int. Cl. G01S 13/04; G01S 13/02

(52) U.S. Cl. CPC G01S 13/04; G01S 13/0209

(57) ABSTRACT

Vehicle systems for monitoring vehicle occupancy and energy harvesting are described herein. An example vehicle system can include at least one occupant sensing component (e.g. UWB radar component, motion sensing component) and at least one sensor element (e.g. electric field sensor, match filter antenna) coupled to at least one vehicle seat. The sensor element can be configured to receive an output signal from the at least one occupant sensing component and transmit a reflected output signal to the at least one occupant sensing component. The vehicle system can include a detecting component (e.g. filtering component, demodulation circuit) operatively coupled to the at least one occupant sensing component and/or the at least one sensor element.

### CROSS REFERENCE TO RELATED APPLICATIONS

This application claims priority to and the benefit of U.S. Provisional Application No. 63/586,752, titled “VEHICLE MONITORING AND ENERGY HARVESTING SYSTEMS AND METHODS,” filed on Sep. 29, 2023, the content of which is hereby incorporated by reference herein in its entirety.

### BACKGROUND

In-vehicle occupancy detectors may rely on the use of a hall effect sensor and permanent magnet which moves position when the tongue is inserted into the buckle assembly so that the hall effect sensor changes state which is detected deterministically through a circuit in a restraints control module (RCM) so that the seat belt buckle state (open/closed) of every seat location with a seatbelt system is known and can support seatbelt reminder or restraint control functions in the vehicle.

These systems are plagued by technical challenges and limitations, many of which are addressed by the embodiments described herein.

### BRIEF SUMMARY OF THE DISCLOSURE

The present disclosure relates generally to in-vehicle occupancy sensing systems and methods that are capable of harvesting energy, for example, from an occupancy sensing component such as an Ultra-wideband (UWB) radar or motion sensing component. The term “vehicle” as used herein includes all of the broadest plain meanings for the term within the context of transportation (i.e., any references to an automobile are for example purposes only and do not limit this disclosure to any one embodiment).

The use of low power high frequency (Gigahertz+) Ultra-wideband (UWB) doppler radars for automotive external sensing is ubiquitous. There is a trend towards inclusion of such radars inside the vehicle to monitor occupancy with a functional target based on the highly reliable detection of even newborn infants through the extraction of physiological signal (e.g. respiration, movement, heartbeat) artifacts through demodulation and signal processing of the radar signals. Such radars operate using multiple transmit and receive antenna elements which can be controlled in patterns to optimally emit radar energy into each spatial area of the vehicle such that sequencing through all patterns results in a fast interrogation of the entire vehicle from a single radar location. Commonly owned disclosures providing prototype radars and describing ultrawide field-of-view, doppler radar and antenna-based approaches include U.S. patent application Ser. No. 11/382,011, published as U.S. Patent Publication No. 2007/0001918 A1 and issued as U.S. Pat. No. 7,898,480 B2, and U.S. patent application Ser. No. 11/627,369, issued as U.S. Pat. No. 7,994,996 B2, the contents of which are incorporated by reference herein in their entirety. In some implementations, other types of UWB radars can be used for in-vehicle occupant presence, classification, and monitoring systems.

Some seat integrated occupancy sensors include the use of thin flexible, stretchable, two-dimensional (2-D), active electrical conductive and/or capacitive printed ink electrode arrays. Such sensors can include multiple layers of conductors and/or insulators to achieve a required sensor performance, for example, shield layers to isolate sensor layers from the negative effects of electromagnetic interference and/or to achieve electromagnetic compatibility (e.g. attenuate electromagnetic signals from the sensor systems). Multiple sensor electrodes can be attached to a single electronic control unit to reduce system cost and complexity (e.g. electrodes in each rear seating surface location attached to a single electronics control unit (ECU), and/or multiple electrodes in the seating surface and/or seating back).

Currently most vehicle seating interior electronics are powered through direct 12 Volt wiring and the communication to the vehicle is through wired digital protocols such as Local Interconnect Network (LIN) or Controller Area Network (CAN). For example, integrated seat weight sensors, capacitive or load cell sensors, seatbelt buckles and retractors, seating controls, and the like, are all directly wired to vehicle power. Seats may have complex degrees of freedom which must be considered in the wiring layout design (e.g. stowed, partially stowed, reclined, and so on). Also, some seats may be completely removed from the vehicle making it difficult or impossible to provide a guaranteed wired power connection.

The proliferation and reliability of wireless protocols supported in vehicles continues to develop, including wireless fidelity (WiFi), Bluetooth, radio frequency identification (RFID), 3G, 4G, and 5G standards. This trend leads toward the concept of the “Internet of Things” (IoT) which would effectively allow for virtually every single mechatronic system (composed of one or more: sensor(s), actuator(s), processor(s)) to be network accessible in one or more protocols and operational domains (for example, a sensor system in one operational mode might use CAN/LIN to publish data, but in another operational mode exchange data through WiFi). This provides the potential for the mechatronic system to improve and evolve over time.

Current state of the art seatbelt buckle switches are often based on the use of a hall effect sensor and a permanent magnet which moves position when the tongue is inserted into the buckle assembly so that the hall effect sensor changes state which is detected deterministically through a circuit in a restraints control module (RCM) so that the seat belt buckle state (open/closed) of every seat location with a seatbelt system is known and can support seatbelt reminder or restraint control functions in the vehicle. Such systems require electrical conductors in each seatbelt buckle. Exemplary systems are described in and U.S. patent application Ser. No. 14/728,325, issued as U.S. Pat. No. 9,527,477, incorporated by reference herein in its entirety, which describes a potential method to complete a wireless power/data circuit when a seatbelt buckle tongue is properly inserted (e.g. buckled) into the buckle assembly.

Occupant detection systems include sensor elements such as an “electric field sensor,” referring to a sensor that generates a signal that is responsive to the influence that an individual or object being sensed has upon an electric field. One form of electric field sensor is a capacitive sensor, wherein the capacitance of one or more electrodes is measured—from the relationship between received and applied signals—for a given electrode configuration. What has commonly been referred to as capacitive sensing actually comprises the distinct mechanisms of what is referred to as “loading mode,” “shunt mode”, and “transmit mode” which correspond to various possible electric currents and/or electric field pathways. In the “shunt mode”, a voltage oscillating at low frequency is applied to a transmit electrode, and the displacement current induced at a receive electrode is measured by sensing electronics, whereby the displacement current may be modified by the body being sensed. In the “loading mode”, the object to be sensed modifies the capacitance of a transmit electrode relative to ground. In the “transmit mode”, the transmit electrode is put into circuit transmission with the user's body, which then becomes a transmitter relative to a receiver, either by direct electrical connection or via capacitive coupling.

Accordingly, the electric field sensor is either what is commonly known as a capacitive sensor, or more generally an electric field sensor, operating in any of the above-described modes. The electric field sensor may include at least one electrode operatively coupled to at least one applied signal so as to generate an electric field proximate to the at least one electrode, responsive to the applied signal. The applied signal, for example, includes either an oscillating or pulsed signal. At least one electrode is operatively coupled to a sensing circuit that outputs at least one response signal responsive to the electric field at the corresponding electrode wherein the response signal is responsive to at least one electric-field-influencing property—for example, dielectric constant, conductivity, size, mass, or distance—of an object proximate to the electric field sensor. For example, for the electric field sensor as a capacitance sensor, the sensing circuit measures the capacitance of at least one electrode with respect to either another electrode or with respect to a surrounding ground, for example, a seat frame of the vehicle seat, connected to circuit ground. The at least one applied signal is, for example, generated by the sensing circuit that also outputs the at least one response signal. The sensing circuit and associated at least one applied signal may be adapted to be responsive to the influence of a water-soaked vehicle seat on measurements from the electric field sensor. The sensor elements or sensors described herein may detect, and record with a computer, an empty vehicle seat, an infant seat, a child seat, or a booster seat on the vehicle seat with or without an infant or child seated therein.

An electrode of the electric field sensor may be constructed in a variety of ways, and the method of construction is not considered limiting. For example, an electrode may be constructed using rigid circuit board or a flexible circuit using known printed circuit board techniques such as etching or deposition of conductive materials applied to a dielectric substrate. Alternately, an electrode may comprise a discrete conductor, such as a conductive film, sheet, or mesh that is distinct from or an integral part of the vehicle seat or components thereof. The assembly of one or more electrodes together with the associated substrate is sometimes referred to as a sensing pad or a capacitive sensing pad.

For the purpose of this disclosure, an example Occupant Monitoring System (OMS) can include at least one occupant sensing component (e.g. UWB radar component) and at least one sensor element (e.g. electric field sensor, match filter antenna, or the like). In this non-limiting example, the at least one occupant sensing component is fixed within a vehicle and the at least one sensor element is operatively coupled to a vehicle seat. The OMS can be configured to monitor the vehicle cabin and can also encompass human occupants and objects within the cabin. Embodiments of the present disclosure can utilize a remote sensor element electrode for unique new functions including occupancy detection, energy harvesting, detecting changes in seat degrees of freedom, and radar sensor diagnostics. In one example, a radiofrequency (RF) resonator coupled to a seatbelt buckle can be enabled and detected through a remote radar sensor without vehicle power supplied to the seatbelt buckle. Unique resonance signals can be selected so each seat location has a unique signal detectable by the radar through received signal processing.

In some implementations, a vehicle system is provided. The vehicle system includes: at least one occupant sensing component (e.g. UWB radar component, motion sensing component); at least one sensor element (e.g. electric field sensor, match filter antenna) coupled to at least one vehicle seat configured to receive an output signal from the at least one occupant sensing component and transmit a reflected output signal to the at least one occupant sensing component; and a detecting component (e.g. filtering component, demodulation circuit) operatively coupled to the at least one occupant sensing component and/or the at least one sensor element.

In some implementations, the detecting component is configured to: responsive to detecting, based at least in part on the reflected output signal or absorbed output signal, that the at least one vehicle seat is unoccupied or is in a first predetermined position, cause the at least one sensor element or another device to harvest or absorb energy from the at least one occupant sensing component.

In some implementations, the detecting component is further configured to: responsive to detecting, based at least in part on the reflected output signal or absorbed output signal, that the at least one vehicle seat is occupied or is in a second predetermined position, cause the at least one sensor element or the another device to stop harvesting/absorbing energy from the at least one occupant sensing component.

In some implementations, the vehicle system further includes a storage component (e.g. battery) for storing the harvested/absorbed energy.

In some implementations, the harvested/absorbed energy is used to power an electronics control unit and/or the at least one vehicle seat.

In some implementations, the at least one sensor element includes the detecting component.

In some implementations, the detecting component includes at least one of a match filter detector, a match filter antenna patch, and a flexible printed conductor.

In some implementations, an output of the detecting component is configured to monitor occupancy of at least one vehicle seat.

In some implementations, the at least one occupant sensing component includes an Ultra-wideband (UWB) radar component.

In some implementations, the at least one occupant sensing component is positioned on an interior surface of the vehicle.

In some implementations, the at least one occupant sensing component is further configured to: responsive to detecting that the at least one vehicle seat is unoccupied or is in one of a plurality of predetermined positions, modify at least one signal parameter of the at least one occupant sensing component (e.g. output signal strength).

In some implementations, the at least one sensor element includes a plurality of sensor elements that are each coupled with (e.g. attached to, positioned on, disposed on) a respective vehicle seat within the vehicle.

In some implementations, the at least one occupant sensing component has a carrier frequency of approximately 60 gigahertz (GHz).

In some implementations, a vehicle system is provided. The vehicle system includes: at least one occupant sensing component (e.g. UWB radar); at least one vehicle seat including a rectenna or passive resonant circuit (e.g. harmonic passive transponder, embedded passive transponder, and/or printed circuit board) in electrical communication with the at least one occupant sensing component configured to: in a buckled position/state (e.g. when a buckle is proximate or within a threshold distance of an in-seat antenna element), effect a resonance response to an output signal (RF radar energy) of the at least one occupant sensing component.

In some implementations, the vehicle system further includes a detector circuit in electrical communication (e.g. hardwired) with the rectenna or passive resonant circuit.

In some implementations, the rectenna or passive resonant circuit (e.g. RF transponder circuit) is embodied as a buckle and tongue, and the rectenna or passive resonant circuit is activated when the tongue is inserted within the buckle.

In some implementations, the rectenna or passive resonant circuit (e.g. RF transponder circuit) includes an inductor/capacitor coupler.

In some implementations, the resonance response to the output signal changes based at least in part on a position of a tongue relative to an in-seat antenna element of the at least one vehicle seat (e.g. based on frequency, duty cycle).

In some implementations, the at least one occupant sensing component is configured to: responsive to detecting, based at least in part on the resonance response, an unbuckled position/state of the vehicle seat, transmit a control signal to trigger generating an alert (e.g. via a display).

In some implementations, the at least one occupant sensing component is configured to: responsive to detecting, based at least in part on the resonance response, an unbuckled position/state of the at least one vehicle seat, cause at least one sensor element (e.g. in-seat antenna element) of the at least one vehicle seat to harvest or absorb energy from the at least one occupant sensing component.

In some implementations, the at least one occupant sensing component is further configured to: responsive to detecting, based at least in part on the resonance response, the unbuckled position/state, modify at least one signal parameter of the at least one occupant sensing component (e.g. output signal strength).

In some implementations, the rectenna or passive resonant circuit is configured to transmit signals within a selected frequency band associated with a respective vehicle seat.

In some implementations, the vehicle system, further includes an additional resonant circuit operatively coupled to the at least one vehicle seat that is configured to transmit signals indicating a vehicle seat state (e.g. bucked, unbuckled) to the at least one occupant sensing component.

In some implementations, a vehicle system is provided. The vehicle system can include at least one occupant sensing component (e.g. UWB radar); a Child Restraint System (CRS) and a corresponding attachment (e.g. International Organization for Standardization (ISO) standard 13216 (ISOFIX) attachment) including a radiofrequency (RF) transponder circuit, wherein the RF transponder circuit is activated when the CRS latches to the corresponding attachment and effects a resonance response to an output signal (e.g. RF radar energy) of the at least one occupant sensing component.

### BRIEF DESCRIPTION OF THE DRAWINGS

These and other features, aspects, and advantages of the present invention will become apparent from the following description and the accompanying exemplary embodiments shown in the drawings, which are briefly described below.

FIG. 1A and FIG. 1B show an example resistive and/or capacitive sensor in accordance with embodiments set forth herein.

FIG. 2 is a schematic illustration of a vehicle system including a sensor element for occupant detection and/or energy harvesting in accordance with embodiments set forth herein.

FIG. 3A, FIG. 3B, and FIG. 3C are schematic illustrations showing example operations of a vehicle system in accordance with embodiments set forth herein.

FIG. 4A, FIG. 4B, FIG. 4C, FIG. 4D, and FIG. 4E are schematic illustrations showing example operations of vehicle systems in accordance with embodiments set forth herein.

FIG. 5 is an overview schematic illustration of a vehicle system in accordance with embodiments set forth herein.

### DETAILED DESCRIPTION

The figures illustrate the exemplary embodiments in detail. However, it should be understood that the application is not limited to the details or methodology set forth in the description or illustrated in the figures. It should also be understood that the terminology is for the purpose of description only and should not be regarded as limiting.

Embodiments of the present disclosure provide resistive and/or capacitive or electric field type sensors for use in an OMS or occupant detecting system (e.g. occupant sensing and/or classification system). A system to detect occupancy of a vehicle seat may be implemented in many ways. For example, in one embodiment, an occupant sensing component (e.g. UWB radar component) is configured to transmit an output signal, and a sensor element (e.g. electric field sensor, electrode) is configured to receive the output signal from the occupant sensing component. In non-limiting embodiments, the composition, structure, and position of the sensor element may be engineered to allow the sensor element to operate in occupant detection mode within numerous kinds of systems with respective circuitry and components. In example embodiments, described below, the sensor element may be an ideal absorber, or a substantially ideal absorber, of the output signal, and an absorbed output signal from the occupant sensing component essentially drives an electrical signal within the sensor element for further data processing, energy harvesting, and the like. In other embodiments, the sensor element may be at least partially reflective of the output signal received from the occupant sensing component and transmit a reflected output signal back to the occupant sensing component for enhanced occupant detection. This disclosure contemplates that various types of occupant sensing components may be used, including radar sensors produced by Vayyar Imaging, Texas Instruments, NXP Semiconductors, and Fury.

The vehicle system can be configured to determine whether a vehicle seat is occupied based at least on a reflected output signal or an absorbed energy signal harvested by the sensor element. According to another embodiment, an alternating current (AC) may be provided to a sensing electrode located in a vehicle seat or other component, such as a steering wheel. The current or change in the current to the sensor may be measured and used as an indicator of the impedance from the sensing electrode to ground. In yet another embodiment, a capacitive sensor can be used to classify the occupant, based at least on the environment above the seat cover which can be sensed using various techniques to identify the dielectric and conductive properties of the occupant. A conductive sensor element is placed in the seat and, according to one embodiment, the impedance from the electrode to ground may be used as an indicator of the occupant status above the seat cover.

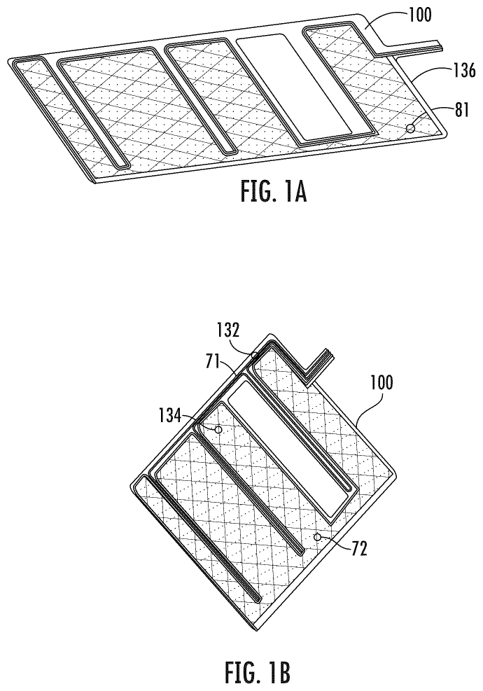

FIGS. 1A and 1B are cross section illustrations of example resistive and/or capacitive sensor, referred to herein as substrate 100. The substrate 100 is illustrated as being transparent for example purposes, and the cross sections are taken through the z-axis (i.e., across the thickness of the substrate 100). FIGS. 1A and 1B, therefore, show that the conductive traces 132 for the resistive sensor circuit and conductive traces 134 for the capacitive sensor circuit define a first pattern 71 (resistive) and a second pattern 72 (capacitive) on the first side of the non-conductive substrate 100 and a third pattern 81 (shielding) on the second side of the sheet substrate 100. In other embodiments, the patterns 71, 72, 81 may be similar or even identical. In one non-limiting example, the conductive traces 132, 134, and 136 on the opposite faces of the sheet substrate 100 operate similarly to separate sensor mats and shielding mats of multi-layered capacitive sensing devices, but with much more flexibility in design and more possible uses that require space saving efficiency not seen in prior devices.

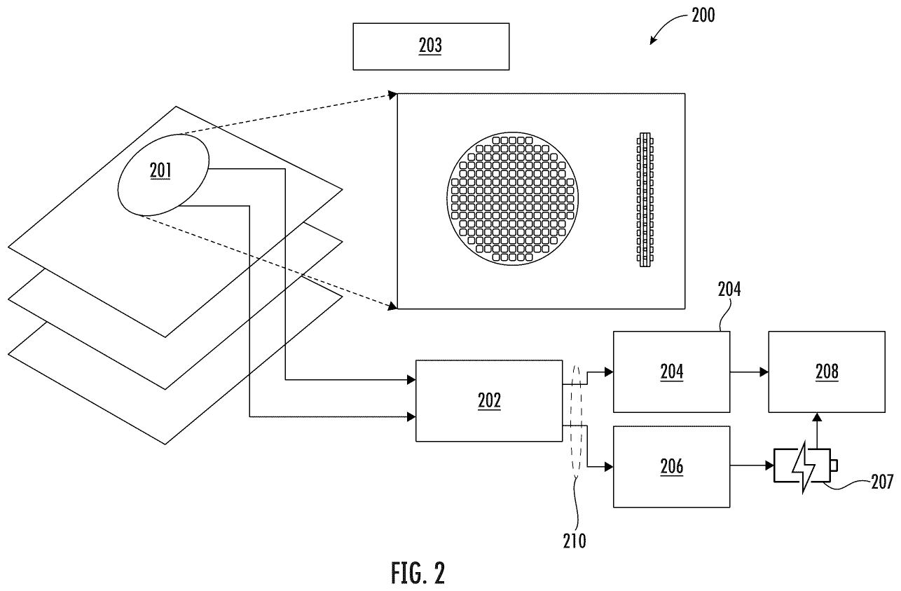

Referring now to FIG. 2, an example vehicle system 200 for vehicle monitoring, occupation detection, and/or energy harvesting is provided. The vehicle system 200 includes a sensor element 201 in electronic communication with an occupant sensing component 203. The occupant sensing component 203 can comprise a UWB radar component. In some examples, the occupant sensing component 203 has a carrier frequency of approximately 60 GHz.

The sensor element 201 may be attached or otherwise affixed to a vehicle seat and can detect the presence of an object in a vehicle seat. The sensor element 201 may include any type of conductive material for the electrodes (e.g. copper, conductive inks, conductive fabrics, etc.) and any compressible material for the spacer between a sensor and a shield (e.g. non-woven felts, woven materials, foams, polymers, dielectrics, materials used to allow air flow for forced air climate control seats, or any other material that will significantly compress at pressures under 1 psi).

In some embodiments, the sensor element 201 comprises an optimized geometric, dielectric antenna printed on a flexible sensor substrate. The sensor element 201 can be or comprise a printed signal detection antenna pattern on one or more layers such that the antenna pattern is designed optimally to resonate (e.g. absorb) the maximal signal power and phase from the occupant sensing component 203 (e.g. an in-vehicle ultrawide (“UWB”) radar system) configured to reliably detect and classify the presence of living/moving occupants inside a vehicle cabin. Commonly owned disclosures describing such systems, including a wide range of adjustable parameters to maximize either transmitted or received signals include U.S. patent application Ser. No. 11/382,011, issued as U.S. Pat. No. 7,898,480 and U.S. patent application Ser. No. 11/627,369, issued as U.S. Pat. No. 7,994,996, the contents of which are incorporated by reference herein in their entirety.

Since the approximate a-priori geometry of one or more sensor elements 201 in the vehicle (e.g. in a movable seat) relative to one or more in-vehicle radars (e.g. occupant sensing component 203) is known, the sensor element 201 (e.g. printed antenna) can be designed based on an average position and orientation of the sensor element 201 based on available degrees of freedom (e.g. occupant selectable settings) when the vehicle is empty (e.g. no occupants). As shown, the sensor element 201 (e.g. printed signal detection antenna) can be electrically connected to or comprise a detecting component 202. The detecting component 202 can comprise a match filter detector, a match filter antenna patch, and/or a flexible printed conductor. In some examples, the detecting component 202 is a signal detection and de-modulation circuit designated as a match filtered detector. The detecting component 202 can use various principles to maximize the radar signal to noise power ratio. In some implementations, a match filter detector output signal 210 can be further applied to additional functions such as an attenuation and movement detector 204 implemented through analog and digital electrical circuits and/or software whereas this function is used to monitor the absorbed signal, S(t), variations over time. If there is no living occupant within the seat, and the radar is operating by design, the absorbed signal will not vary (or will vary deterministically, for example, if the demodulation process results in a positive voltage AC intermediate frequency signal) such that signal processing and detection logic can be a-priori defined to classify no human occupant in/around the seat. In some implementations, the sensor element 201 includes an independent electronic control circuit that can wirelessly transmit state information independent of the radar (e.g. via Bluetooth or WiFi) to any other vehicle system or component that wants to receive it (e.g. body controller, infotainment, and the like).

Additionally, and/or alternatively, the match filtered detector signal can also be used in a separate function in a radio frequency (RF) energy harvesting circuit 206 as shown in FIG. 2. For example, in response to detecting, based at least on the absorbed output signal, that the vehicle seat is unoccupied or in a predetermined position (e.g. stowed, or folded), the vehicle system 200 may cause the sensor element 201 to harvest or absorb energy from the occupant sensing component 203 (e.g. UWB radar system). Similarly, in response to detecting, based at least on the absorbed output signal, that the vehicle seat is occupied or in a different predetermined position (e.g. unstowed), the vehicle system 200 may cause the sensor element 201 to stop harvesting/absorbing energy from the occupant sensing component 203.

In some implementations, as shown, the attenuation and movement detector 204 and radio-frequency (RF) energy harvesting circuit 206 are combined and included in the ECU 208. The output energy of the harvesting circuit (e.g. a positive voltage and current) could be used to charge a storage component 207 (e.g. battery) that is subsequently used by the sensor element 201 to power the functions described herein and/or other independent functions of the sensor element 201 (e.g. sensing, diagnostics, wired/wireless digital communication with another vehicle's ECU, including potentially the UWB radar (occupant sensing component 203), for example, to provide functional diagnostics for the radar operation and/or higher Automotive Safety Integrity Level (ASIL) functional levels of the vehicle occupancy detection system and/or other functional use cases supported by the radar (e.g. occupant classification, in/out of position, and the like).

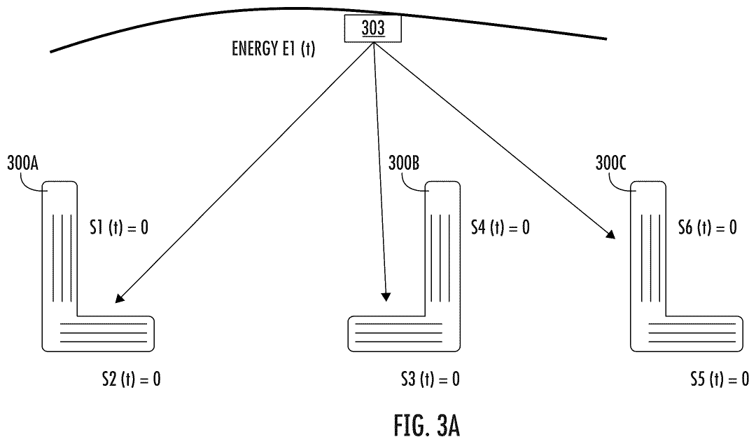

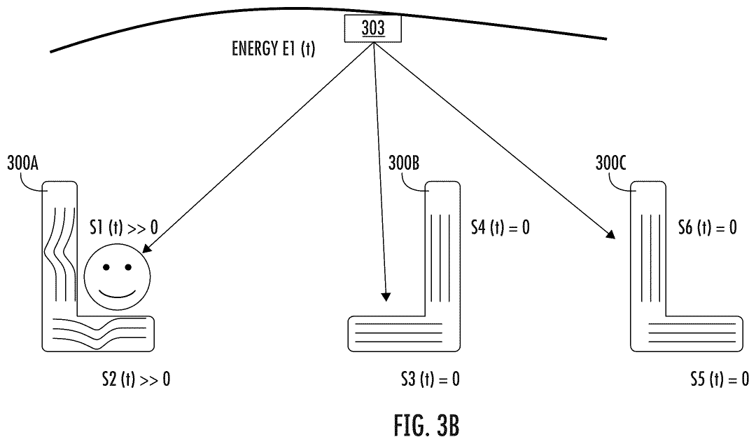

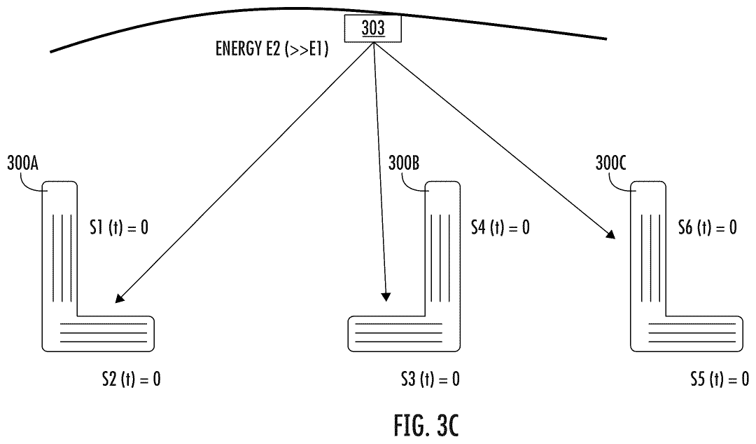

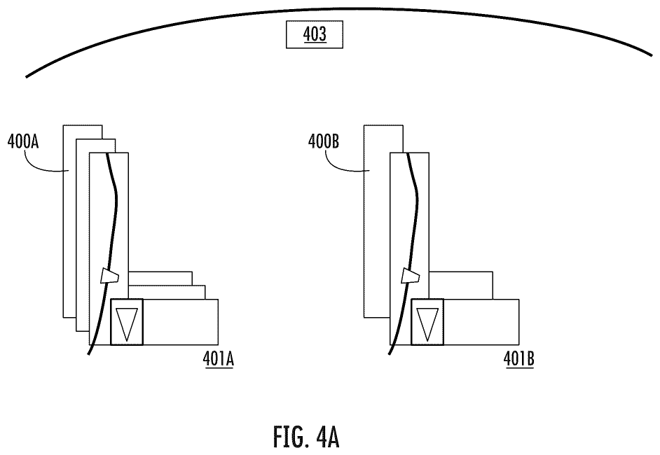

Referring now to FIG. 3A, FIG. 3B, and FIG. 3C, schematic illustrations showing example operations of a vehicle system (such as, but not limited to, the vehicle system 200 described above in connection with FIG. 2) are provided. In some examples, a match filter detector output signal 210 (or other output signal of another type of detecting component) can be used to detect vehicle seat occupancy by monitoring absorbed signal S(t) variations over time.

In the example, shown in FIG. 3A, the vehicle system determines that the vehicle (e.g. at least one vehicle seat 300A, 300B, 300C) is unoccupied. If there is no living occupant within the seat, and the occupant sensing component 303 (e.g. UWB radar) is operating by design, the signal absorbed by the sensor element coupled to each vehicle seat 300A, 300B, 300C (e.g. sensor element 201 described above in connection with FIG. 2) will not vary (or will vary deterministically, for example, if the demodulation process results in a positive voltage AC intermediate frequency signal) such that signal processing and detection logic can be a-priori defined to classify no human occupant in/around the seat.

In the example shown in FIG. 3B, the vehicle system determines that the vehicle (e.g. at least one vehicle seat 300A, 300B, 300C) is occupied. If one or more living/moving occupants are in a seat containing a sensor element coupled to each vehicle seat 300A, 300B, 300C (e.g. sensor element 201 described above in connection with FIG. 2), and the radar is operating as intended with a constant peak transmit power, the occupant's physical movements can result in two effects that result in amplitude and frequency changes in the output of the match filtered detector signal, S(t). First, any mechanical movement of the flexible sensor element, will attenuate the optimal resistant signal (e.g. antenna elements moving and shifting in one or more of six possible degrees of freedom (e.g. vector displacements and/or rotations of the antenna pattern). However, if the moving/living occupant is not mechanically coupled to the sensor element but is in the line of sight or in proximity to the sensor element, movement will also induce amplitude and phase changes in the match filtered detector signal, S(t). Through system simulation, such as computer-aided engineering (CAE) and/or a-priori testing, detection logic can be derived (including thresholds and signal features) that can be used to indicate occupant presence as depicted in FIG. 3B. In a similar manner, if the vehicle seat 300A, 300B, 300C is re-positioned into new supported degrees of freedom (e.g. stowed or folded), the average detected signal will change. Again, if these conditions are a-priori modelled and/or tested, detection logic can be used to detect those new degree of freedom states and associated countermeasures derived (e.g. send updated state information to be used by vehicle ECU's and/or the radar system).

As illustrated in FIG. 3C, if the vehicle occupancy presence is confirmed with high confidence to be empty, and/or a new seating state condition is determined, this information could be used by the vehicle system/radar system to change the signal parameters of the radar to improve radar detection and/or increase power levels (which could also be used to improve energy harvesting efficiency, for example). For example, responsive to detecting that at least one vehicle seat 300A, 300B, or 300C is unoccupied or is in one of a plurality of predetermined positions, the vehicle system can modify at least one signal parameter of the occupant sensing component 303, such as, but not limited to, the output signal strength.

As described in more detail herein, components of the match filter examples can theoretically include a patch antenna in a seat belt assembly and a resonant circuit such that the selected resonance characteristics are only enabled when the buckle is properly buckled. For example, the resonance frequency can be tuned uniquely for each vehicle seat such that a radar wave impinging the match filter circuit induces a unique resonance effect in the reflected wave received by the radar. Demodulation circuitry and software can be designed to detect the unique resonance artifacts and through detection infer the seatbelt buckle state (e.g. unbuckled—no resonance artifact detected; buckled—deterministic resonance artifact detected). Accordingly, the radar system can report the buckle state through vehicle communication networks.

For example, a buckle and tongue assembly can include separate components of a resonance circuit (resistor (R), inductor (L), capacitor (C), also referred to as “RLC”) where the circuit is “completed” when the buckle is properly buckled, for example, using the circuit connection methods described in U.S. patent application Ser. No. 14/728,325, issued as U.S. Pat. No. 9,527,477, the contents of which are incorporated herein by reference in their entirety. Alternatively, this functionality can be implemented through a direct physical metal conductor connection when the tongue is properly buckled into the buckle assembly. An alternative embodiment to that described in relation to FIG. 3A, FIG. 3B, and FIG. 3C could be achieved through a rectifying antenna (“rectenna”) circuit which is only completed when the seatbelt is properly buckled. In some implementations, the rectenna (or passive resonant circuit) is configured to transmit signals within a selected frequency band associated with a particular vehicle seat. The rectenna or passive resonant circuit can comprise an inductor/capacitor coupler. In some examples, an additional resonant circuit operatively coupled to the at least one vehicle seat is configured to transmit signals indicating a vehicle seat state (e.g., bucked, unbuckled) to the occupant sensing component. Similar to the vehicle system 200 described in connection with FIG. 2, a detector circuit or detecting component can be in electrical communication with the rectenna or passive resonant circuit.

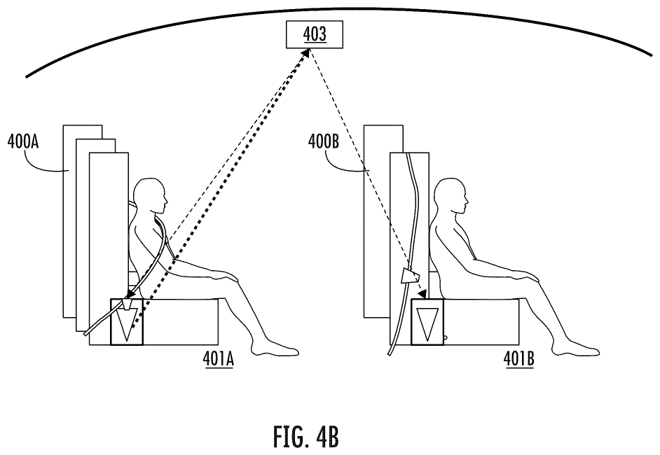

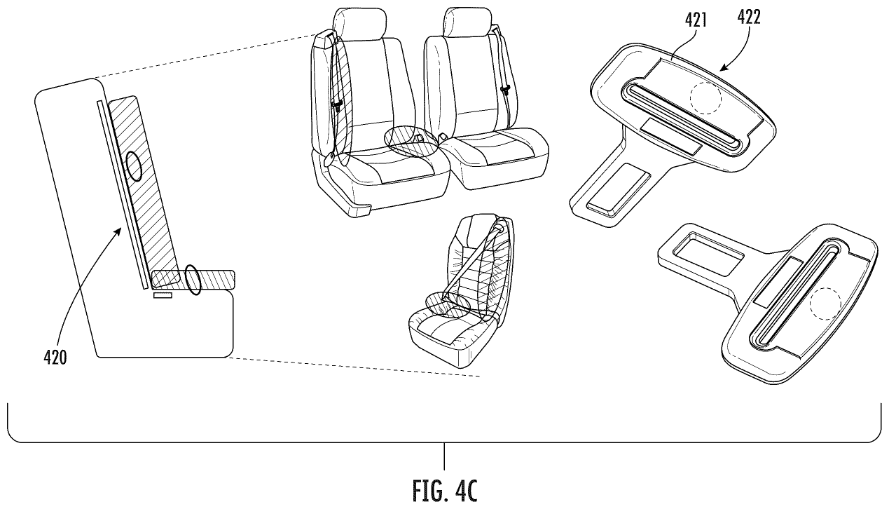

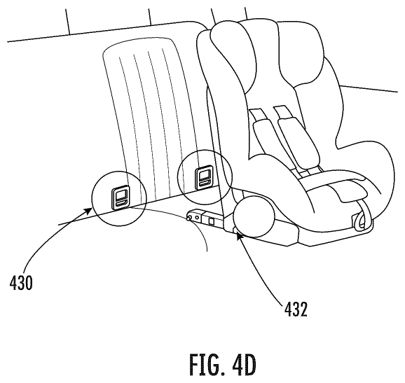

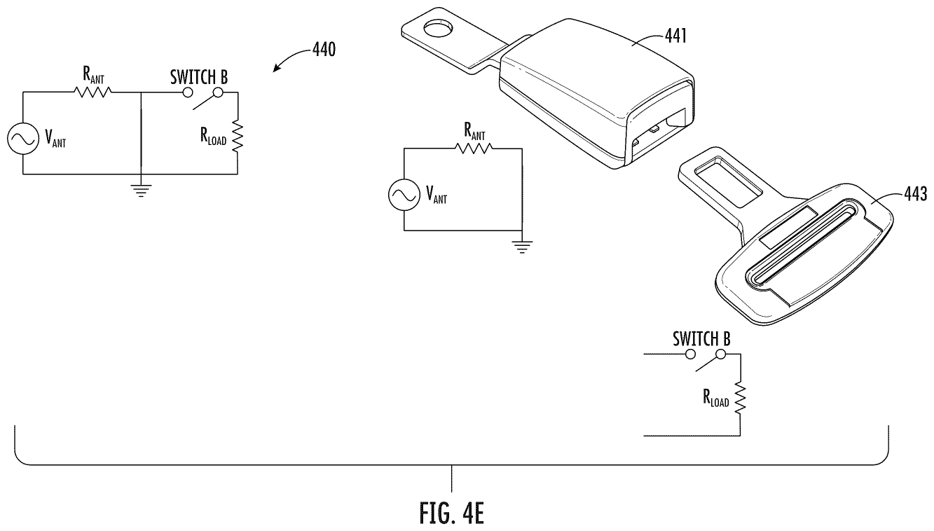

FIG. 4A and FIG. 4B are schematic illustrations showing example operations of a vehicle system that includes rectenna circuits 401A, 401B. The rectenna circuit 401A, 401B can include and drive an active RF oscillator transmitter where the oscillator generates a specific coded RF electromagnetic field signal that can be detected by a radar (e.g. a discrete “noise” frequency source that can be detected intentionally within the radar signal processing to indicate the buckle open/closed state). Unique oscillator signals can be created for each seating location to support seatbelt reminder functions in the radar system.

A rectenna can be used to store the radiated energy and fed into a microprocessor to transmit a selected band in the UWB sweep to specifically identify seats with unique signatures. In the example shown in FIG. 4A, a first vehicle seat 400A has a 62.35 GHz signal, and a second vehicle seat 400B has a 61.05 GHz signal. Referring now to FIG. 4B, closure of a small circuit within a buckle apparatus of each vehicle seat 400A, 400B can indicate closure with high confidence. An example circuit can be powered by energy collected by the rectenna and will not require wires from main vehicle power or traditional CAN/LIN communication busses.

In some implementations, a seat integrated seatbelt having a passive resonant circuit with transponder reflected response is provided. In various implementations, the passive resonant circuit may be or comprise a harmonic passive transponder, an embedded passive transponder, and/or a PCB. In a normal unbuckled state, as shown in FIG. 4C (and even if buckled with no occupant) the buckle is proximal to a surface of a vehicle seat 420.

As further depicted in FIG. 4C, a vehicle seat buckle 421 can comprise an integrated RF resonant circuit 422. The RF resonant circuit 422 can be embedded in plastic and can include an inductor/capacitor coupler. The system operation may be similar to a Radio-frequency identification (RFID) badge. Specifically, the resonance response to RF radar energy changes based on the position of the resonant tongue (e.g. RF resonant circuit 422) relative to an in-seat antenna element. Proximity can complete the resonant transponder response (e.g. frequency, duty cycle, and/or the like). In some implementations, the tongue and buckle form an electrical connection (metal to metal) with required RLC components embedded in the tongue and complimentary elements in the buckle. In this way, the circuit is open when the buckle is unbuckled and when buckled, the circuit is completed, and the transponder activates. Distinct patterns may be generated for “open” and “close” regions. The resonance circuit changes to affect a resonance response in a reflected radar return when buckle switch is “closed”. In some examples, each in-seat antenna at different positions in the vehicle, such as on individual seats, would tune to a different resonant frequency so that a single receiver can distinguish all of the outputs with the same piece of hardware. In some implementations, responsive to detecting, based at least in part on the resonance response, an unbuckled position/state of the vehicle seat, the vehicle system (e.g., occupant sensing component 403 or the integrated RF resonant circuit 422) can transmit a control signal to trigger generating an alert (e.g., via a display) and/or cause at least one sensor element (e.g., in-seat antenna element) of a vehicle seat to harvest or absorb energy from the at least one occupant sensing component.

In the example shown in FIG. 4D, an embedded passive transponder activates only when an International Organization for Standardization (ISO) standard 13216 (ISOFIX) attachment 430 is properly fixated to a Child Restraint System (CRS) 432. In particular, a passive antenna or other component can complete an example resonant harmonic transponder when the CRS 432 latches to an ISOFIX attachment 430. Embodiments of the present disclosure contemplate other attachments and standards for vehicle systems, including the Lower Anchors and Tethers for Children (LATCH) system and the Universal Child Safety Seat System (UCSSS). In various examples, the vehicle system can be configured to differentiate between a hybrid CRS when in front and rear facing modes (e.g. based at least on a different detected frequency or duty cycle transponder signal).

Referring now to FIG. 4E, in some embodiments, an example vehicle system can include a buckle 441 having an integrated buckle and tongue RF transponder circuit 440. The buckle 441 can include circuitry (the buckle and tongue RF transponder circuit 440), for example, integrated in the plastic mold of the buckle 441 to optimize sensitivity to radar boresight. In some examples, the R_{load} of the circuit 440 is integrated in the buckle tongue 443 (e.g. embedded in plastic). When the buckle tongue 443 latches in the buckle 441, switch B in the circuit 440 is closed. Switching RF loads with different impedances results in two modulation states of high and low power radiated backscatter signals. For example, if switch A and switch B are not connected (open state) no energy is released, while all received power is re-radiated again by connecting only switch A (short or bucked state). The switch circuit of the buckle and tongue RF transponder circuit 440 controls the switches A and B to connect the ground or chip impedance R_{load}.

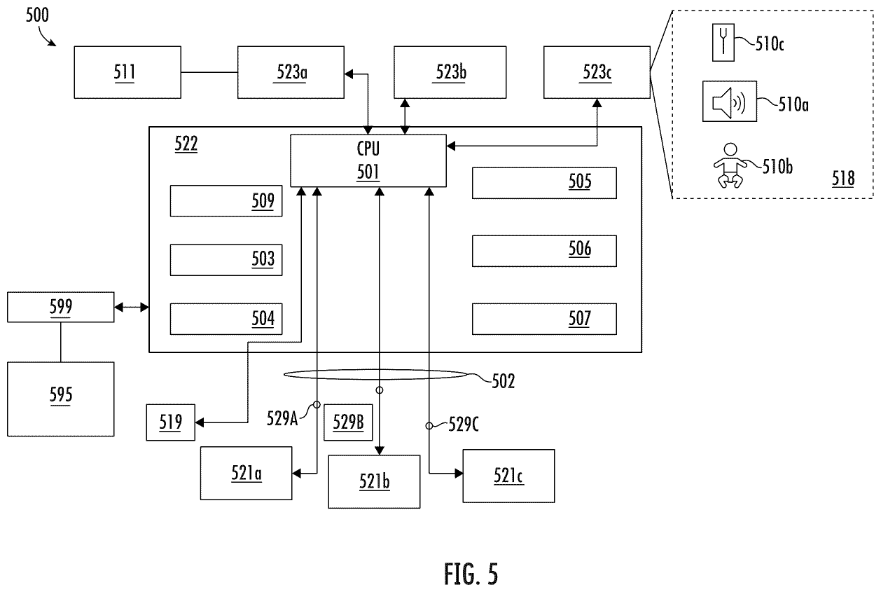

FIG. 5 is a schematic illustration of a vehicle system 500 that can include embodiments of the present disclosure described herein. The vehicle system may include an Occupant Monitoring System (OMS) 599 and OMS sensors 595 (e.g. at least one occupant sensing component such as a UWB radar) configured to identify and/or classify occupant in a vehicle. Once the occupant classification is completed with a variety of sensor types, the controller/microcontroller/central processing unit (CPU) 501 of FIG. 5 may use the occupant classification data to provide control signals to other systems including but not limited to a steering wheel lighting system (i.e., a “lightbar” 511), steering control and assisted driving algorithms 523a, a braking system 523b, and a warning system 523c discussed further in the below disclosure. The various systems receiving data and control information within the vehicle system 500 is not limited to those shown in FIG. 5 because the schematic representation of the vehicle system therein is non-limiting and may include any other vehicle system that can be controlled from a computer in data communication with the vehicle components. The overall vehicle computer environment 522 may include not only the CPU 501, but other computerized components including but not limited to random access memory 509, read only memory 503, computer memory and storage 504, database and information storage structures 505, other input/output devices 506 and associated connections, as well as numerous computer interfaces 507 that interact with vehicle hardware.

One example embodiment utilizes the various data received from at least one sensing circuit 502 of sensor elements 521A, 521B, 521C, the number of which is entirely optional. As shown in FIG. 5, computerized embodiments herein utilize computer programs having computer instructions that implement warning algorithms based on information regarding the classification of each occupant and other control data received by the CPU 501, particularly other control data indicating that the driver or last remaining adult or older child is exiting the vehicle. This other control data may include indicators from numerous vehicle sensors indicating that the vehicle has stopped or parked, the ignition has been switched off, audio-visual accessories have been switched off, park brake engagement, or image data showing occupants exiting the vehicle. This other control data 519 may be transmitted to the CPU 501 from numerous interfaces 507 connected to vehicle control sensors that are part of an overall vehicle control and communication system. All of this information may be utilized to implement a warning system 523C, particularly a warning system to prevent abandoning a child who is unable to exit the vehicle themselves and should not be left unattended. As shown in FIG. 5, the warning system may include an audible warning signal 510A, a visible warning signal 510B, and a haptic warning signal 510C.

In one example embodiment, a passenger protection system for a vehicle includes a vehicle system 500 having at least one processor 501 and computerized memory 504 storing vehicle control software therein, wherein the vehicle control software receives input data 529A, 529B, 529C from a plurality of sensor elements 521A, 521B, 521C, such as a respective reflected output signal for a vehicle seat. Using this sensor input data, the processor (i.e., CPU, microprocessor, or controller) 501 identifies a presence of at least one occupant, such as a passenger other than a driver in the vehicle, and that identification triggers a digital control sequence implemented by the CPU 501 and/or other vehicle control computers that are active during vehicle use. In one embodiment, the digital control sequence functions to issue at least one warning signal from a computerized warning system 523C in data communication with the CPU 501. The at least one warning signal is activated in a way that is likely to be noticed by an occupant, such as the driver or other passenger occupants in the vehicle, to alert the occupant that at least one other passenger occupant, such as a child that needs care, is in the vehicle and should be attended before everyone else exits the vehicle. In some implementations, the digital control sequence activates and de-activates an alert system 518 within the vehicle that is useful to prevent forgetting an occupant in the vehicle when that occupant cannot take care of themselves and/or cannot exit the vehicle themselves. The warnings may take on any form, placement, frequency, volume, intensity, or other characteristics, but in one non-limiting embodiment, the alert system 518 implements warning signals or alerts 510A, 510B, 510C on or near a door of the vehicle where an adult would exit. In the embodiments of this disclosure, the alert system 518 includes at least one of an audible alert 510A and/or a visible alert 510B and/or a haptic alert 510C on or near the door of the vehicle because the door is often the object of a vehicle occupant's attention when exiting a vehicle. The audible alert may be any sound that is perceptible by a vehicle occupant and easily interpreted as requiring attention, such as, but not limited to, an automated voice attendant, a beeping sound, a siren sound, or any other audible input to the vehicle occupants. The visible alert may include any number of lighting arrangements that are positioned and colored to catch the attention of occupants before exiting the vehicle. A haptic alert may be any signal that can be perceived by touch, such as vibrations, to provide an indicator that an occupant is possibly being left in the vehicle by accident. The digital control sequence, implemented by computerized instructions in software, may activate the alert system 518 and associated warning signals or alerts 510A, 510B, 510C in any order, i.e., simultaneously, sequentially, and in any combination. In one non-limiting example, the order of alerts may increment as time passes or upon the sensor control system 500 utilizing input data 529 to determine that events within the vehicle are progressing toward an occupant such as the driver leaving the vehicle with a child therein. The input data may originate from numerous sensors and images described above and may further include door sensors indicating that the door is opened, and the driver is moving out of the driver seat in the vehicle. In one example, an alert sequence may include the visible alert 510B, followed by the haptic alert 510C, followed by the audible alert 510A.

The vehicle sensor control system 500 uses computerized components to implement the digital control sequence that activates the alert system 518. The alert system 518 uses the digital control sequence to activate monitoring and alerting vehicle occupants in a passenger protection system as described herein. To accomplish the alerts, an overall passenger protection system illustrated generally at FIG. 5 is in electronic communication with an occupant monitoring system (the above noted OMS) and/or an occupant classification system (OCS) having at least one occupant classification (OC) sensor detecting the presence of the occupant other than the driver or other adults in the vehicle. The OC sensor may include any of a weight sensor, capacitive sensor, or any other tracking device by which the CPU of the sensor control system can be activated by the presence of adults and children in the vehicle.

In another embodiment, a passenger protection system for a vehicle includes a vehicle sensor control system 500 in data communication with at least one processor 501 and computerized memory/computerized storage 504 for storing vehicle control software therein, wherein the vehicle control software receives input data 529 from a plurality of vehicle sensors 521. An occupant monitoring system 599 is also connected to and in data communication with the plurality of sensor elements 521 configured to identify a presence of a driver and at least one other occupant in the vehicle, the occupant monitoring system 599 further having additional sensors 595 classifying the driver and the other occupant according to a passenger classification system stored in the software. A digital control sequence may be triggered in the software by a presence of the at least one occupant other than a driver in the vehicle, the digital control sequence activating and de-activating an alert system 518 within the vehicle. The alert system may include at least one of an audible alert 510A and/or a visible alert 510B and/or a haptic alert 510C. These alerts may be associated with corresponding hardware positioned on or in proximity to the at least one door of the vehicle. Additional sensors, whether sensor elements or other sensors, classifying the driver and the other occupant, configure the software to utilize the digital control sequence, for example, when a child is present in the vehicle, and that child is likely not able to care for themselves, cannot exit the vehicle by themselves, and should not be left unattended in a vehicle after all other occupants leave. The additional sensors may include image sensors and other occupant classification sensors that classify the driver and the other occupant according to weight or size. The additional sensors and associated input data classifying the driver and the other occupant may be at least one of an imaging device, a seat belt sensor, a size sensor, a weight sensor, a capacitive sensor, and the like.

For purposes of this disclosure, the term “coupled” means the joining of two components (electrical, mechanical, or magnetic) directly or indirectly to one another. Such joining may be stationary in nature or movable in nature. Such joining may be achieved with the two components (electrical or mechanical) and any additional intermediate members being integrally defined as a single unitary body with one another or with the two components or the two components and any additional member being attached to one another. Such joining may be permanent in nature or alternatively may be removable or releasable in nature.

The present disclosure has been described with reference to example embodiments, however persons skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g. variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability.

Accordingly, all such modifications are intended to be included within the scope of the present disclosure. Other substitutions, modifications, changes, and omissions may be made in the design, operating conditions, and arrangement of the preferred and other exemplary embodiments without departing from the spirit of the present subject matter.

In example implementations, at least some portions of the activities may be implemented in software provisioned on a networking device. In some embodiments, one or more of these features may be implemented in computer hardware, provided external to these elements, or consolidated in any appropriate manner to achieve the intended functionality. The various network elements may include software (or reciprocating software) that can coordinate image development across domains such as time, amplitude, depths, and various classification measures that detect movement across frames of image data and further detect particular objects in the field of view in order to achieve the operations as outlined herein. In still other embodiments, these elements may include any suitable algorithms, hardware, software, components, modules, interfaces, or objects that facilitate the operations thereof.

Furthermore, computer systems described and shown herein (and/or their associated structures) may also include suitable interfaces for receiving, transmitting, and/or otherwise communicating data or information in a network environment. Additionally, some of the processors and memory elements associated with the various nodes may be removed, or otherwise consolidated such that single processor and a single memory element are responsible for certain activities. In a general sense, the arrangements depicted in the Figures may be more logical in their representations, whereas a physical architecture may include various permutations, combinations, and/or hybrids of these elements. It is imperative to note that countless possible design configurations can be used to achieve the operational objectives outlined here. Accordingly, the associated infrastructure has a myriad of substitute arrangements, design choices, device possibilities, hardware configurations, software implementations, equipment options, etc.

In some of example embodiments, one or more memory elements (e.g. memory can store data used for the operations described herein. This includes the memory being able to store instructions (e.g. software, logic, code, etc.) in non-transitory media, such that the instructions are executed to carry out the activities described in this Specification. A processor can execute any type of computer readable instructions associated with the data to achieve the operations detailed herein in this Specification. In one example, processors (e.g. processor) could transform an element or an article (e.g. data) from one state or thing to another state or thing. In another example, the activities outlined herein may be implemented with fixed logic or programmable logic (e.g. software/computer instructions executed by a processor) and the elements identified herein could be some type of a programmable processor, programmable digital logic (e.g. a field programmable gate array (FPGA), an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

These devices may further keep information in any suitable type of non-transitory storage medium (e.g. random access memory (RAM), read only memory (ROM), field programmable gate array (FPGA), erasable programmable read only memory (EPROM), electrically erasable programmable ROM (EEPROM), etc.), software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’

1. A vehicle system comprising:
at least one occupant sensing component;
at least one sensor element coupled to at least one vehicle seat configured to receive an output signal from the at least one occupant sensing component and transmit a reflected output signal to the at least one occupant sensing component; and
a detecting component operatively coupled to the at least one occupant sensing component and/or the at least one sensor element.

2. The vehicle system of claim 1, wherein the detecting component is configured to:
responsive to detecting, based at least in part on the reflected output signal or absorbed output signal, that the at least one vehicle seat is unoccupied or is in a first predetermined position, cause the at least one sensor element or another device to harvest or absorb energy from the at least one occupant sensing component.

3. The vehicle system of claim 2, wherein the detecting component is further configured to:
responsive to detecting, based at least in part on the reflected output signal or absorbed output signal, that the at least one vehicle seat is occupied or is in a second predetermined position, cause the at least one sensor element or the another device to stop harvesting or absorbing energy from the at least one occupant sensing component.

4. The vehicle system of claim 2, further comprising:
a storage component for storing the harvested or absorbed energy, wherein the harvested or absorbed energy is used to power an electronics control unit and/or the at least one vehicle seat.

5. The vehicle system of claim 1, wherein the detecting component comprises at least one of a match filter detector, a match filter antenna patch, and a flexible printed conductor, and wherein an output of the detecting component is configured to monitor occupancy of at least one vehicle seat.

6. The vehicle system of claim 1, wherein the at least one occupant sensing component comprises an Ultra-wideband (UWB) radar component.

7. The vehicle system of claim 1, wherein the at least one occupant sensing component is further configured to be:
responsive to detecting that the at least one vehicle seat is unoccupied or is in one of a plurality of predetermined positions, modify at least one signal parameter of the at least one occupant sensing component.

8. The vehicle system of claim 1, wherein the at least one sensor element comprises a plurality of sensor elements that are each coupled with a respective vehicle seat.

9. The vehicle system of claim 1, wherein the at least one occupant sensing component has a carrier frequency of approximately 60 gigahertz (GHz).

10. A vehicle system comprising:
at least one occupant sensing component;
at least one vehicle seat comprising a rectenna or passive resonant circuit in electrical communication with the at least one occupant sensing component configured to:
in a buckled position or state, effect a resonance response to an output signal of the at least one occupant sensing component.

11. The vehicle system of claim 10, further comprising:
a detector circuit in electrical communication with the rectenna or passive resonant circuit.

12. The vehicle system of claim 10, wherein:
the rectenna or passive resonant circuit is embodied as a buckle and tongue, and
the rectenna or passive resonant circuit is activated when the tongue is inserted within the buckle.

13. The vehicle system of claim 12, wherein the rectenna or passive resonant circuit comprises an inductor/capacitor coupler.

14. The vehicle system of claim 12, wherein the resonance response to the output signal changes based at least in part on a position of the tongue relative to an in-seat antenna element of the at least one vehicle seat.

15. The vehicle system of claim 10, wherein the at least one occupant sensing component is configured to:
responsive to detecting, based at least in part on the resonance response, an unbuckled position/state of the at least one vehicle seat, transmit a control signal to trigger generating an alert.

16. The vehicle system of claim 10, wherein the at least one occupant sensing component is configured to:
responsive to detecting, based at least in part on the resonance response, an unbuckled position or state of the at least one vehicle seat, cause at least one sensor element of the at least one vehicle seat to harvest or absorb energy from the at least one occupant sensing component.

17. The vehicle system of claim 16, wherein the at least one occupant sensing component is further configured to:
responsive to detecting, based at least in part on the resonance response, the unbuckled position or state, modify at least one signal parameter of the at least one occupant sensing component.

18. The vehicle system of claim 12, wherein the rectenna or passive resonant circuit is configured to transmit signals within a selected frequency band associated with a respective vehicle seat.

19. The vehicle system of claim 12, further comprising:
an additional resonant circuit operatively coupled to the at least one vehicle seat that is configured to transmit signals indicating a vehicle seat state to the at least one occupant sensing component.

20. A vehicle system comprising:
at least one occupant sensing component; and
a Child Restraint System (CRS) and a corresponding attachment comprising a radiofrequency (RF) transponder circuit,
wherein the RF transponder circuit is activated when the CRS latches to the corresponding attachment and effects a resonance response to an output signal of the at least one occupant sensing component.
